(19) United States
(12) Patent Application Publication
(10) Pub. No.: US 2019/0210079 A1
(43) Pub. Date: Jul. 11, 2019

(54) STICK FOR MECHANICAL CLEANING OF PIPES

(71) Applicant: R&O LAB SPRL, Gembloux (BE)

(72) Inventor: Ismaël DJELASSI, Groot-Bijgaarden (BE)

(21) Appl. No.: 16/311,739

(22) PCT Filed: Jun. 21, 2017
(86) PCT No.: PCT/EP2017/065266

§ 371 Date: Dec. 20, 2018

(30) Foreign Application Priority Data
Jun. 28, 2016 (BE) 2016/5488

(51) Int. Cl. B08B 9/057; B08B 1/00; B08B 1/04; B08B 3/08

(52) U.S. Cl. CPC B08B 9/057; B08B 3/08; B08B 1/04; B08B 1/005

(57) ABSTRACT

The invention relates to a stick for the cleaning of household wastewater pipes, designed to be immobilized in the inlet of the pipe and to dissolve, under the action of the water, and release a cleaning agent. It is designed to perform mechanical cleaning in addition to the action of the agent. In order to do this, the stick is rotated under the action of the water, for example by virtue of a helicoidal relief (2) or of rotary vanes (5) on its wall.

### FIELD OF THE INVENTION

The invention relates to sticks for cleaning and degreasing, containing active agents to prevent fouling household pipes, that are placed, for example, in sink or washbasin siphons.

### STATE OF THE ART

At present, there are different degreasing sticks for household pipes, more generally for household wastewater pipes.

These sticks are first placed in a drainage plug before being blocked in the siphon, by virtue of their elongated shape. The sticks are disintegrated and dissolved under the action of the flow of water. During the dissolution, active agents contained in the sticks are released to act on grease and clean the pipes.

These sticks comprise active agents, with chemical and/or biological functions, mixed with a polymer acting as a support. The mixture is shaped into a stick by extrusion or by molding.

Once the stick is blocked in the siphon, it is advisable to wait a certain period of time, usually one month, before putting another one in. This precaution avoids blocking the siphon with several sticks that may not have decomposed. However, depending on the situation, the sticks will dissolve more or less quickly.

The present invention aims to improve the cleaning efficiency of said sticks.

### SUMMARY OF THE INVENTION

For this purpose, the present application relates to a stick for the cleaning of household wastewater pipe designed to be blocked at the inlet of the pipe and, under the action of water, to dissolve and release a cleaning agent and, in addition to the action of the agent, perform a mechanical cleaning, the stick being characterized in that it is designed to be rotated under the action of water.

Said stick is used for all types of domestic pipes, such as sanitary or household pipes. This stick is placed in a drainage plug before being blocked at the inlet of the pipe, by virtue of its elongated shape. The inlet of the pipe is the portion of the pipe adjacent to the drainage plug, such as a siphon.

The stick of the invention comprises a dual function of cleaning the pipes, making it more efficient. Indeed, it is designed, in addition to the action of the agent, to perform a mechanical cleaning.

Preferably, the stick comprises a helicoidal relief on its wall.

The helicoidal shape allows the stick to add a mechanical cleaning to the action of the agent. Following the flow of water on the stick, it is carried away and rotates by virtue of the helicoidal shape of its relief. A swirl is then created in the siphon. On the one hand, this swirl of water provides cleaning by scraping the walls of the pipe. And on the other hand, the stick, when made to rotate, also scrapes the wall of the pipe.

This cleaning stick of the invention has a very high efficiency. Indeed, in addition to the breakdown of grease, it allows scraping the walls of the siphon. Mechanical cleaning provides a more efficient pipe cleaning.

Advantageously, the stick comprises means for scraping the walls of the pipes. These means can be achieved, for example, by barbs on the surface of the cleaning stick.

### BRIEF DESCRIPTION OF THE FIGURES

The invention will be better understood with the aid of the following detailed description, made with reference to the drawing found in the appendix, in which:

FIG. 1 is a front view of a first embodiment of the stick of the invention;

FIG. 2 is a front view of a second embodiment of the stick of the invention;

FIG. 3 is a front view of a third embodiment of the stick of the invention and

FIG. 4 is a front view of a fourth embodiment of the stick of the invention.

### DETAILED DESCRIPTION OF THE INVENTION

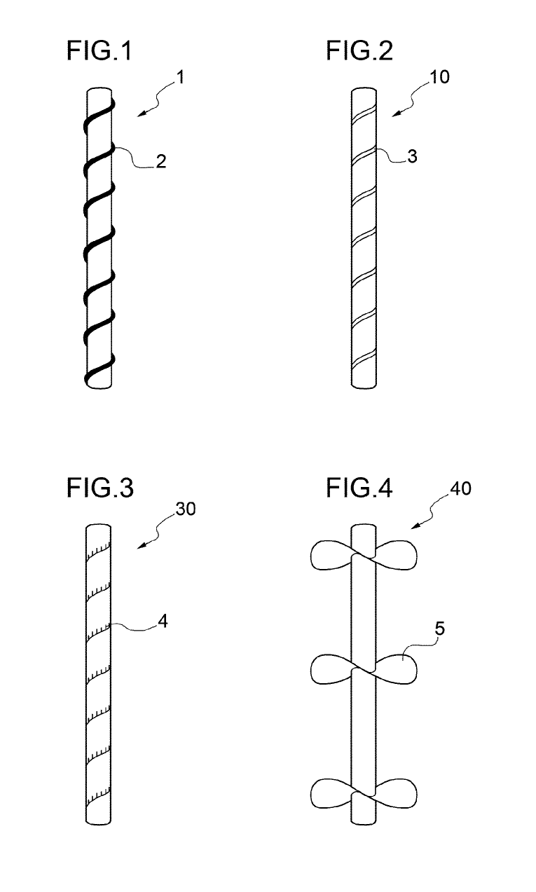

As shown in FIG. 1, the cleaning stick 1 is a thin stick of general cylindrical shape. Said stick comprises a helicoidal relief. This helical relief is made using, here, a rib 2 on the outer surface of the stick, which could also include several ribs.

In FIG. 2, the helical shape is realized here by a groove 3 hollowed on the surface of the stick.

The stick comprises chemical or biological active agents, on a polymeric support, whose purpose is to break down grease and residues found in the pipes. These active agents can be of any type.

In addition, barbs 4 are also provided on the surface of the stick 30 for scraping the walls of the siphon, as illustrated in FIG. 3.

It may be envisaged that the barbs be replaced by a rough surface or other elements to scrape the surfaces of the siphon.

The cleaning stick is placed, for example, in a drainage plug of a sink and is blocked in the siphon by virtue of its elongated shape. Following the flow of water on the stick, said stick rotates in the siphon by virtue of the helical shape of its relief. Indeed, the water will rush in between the ribs 2, causing the stick to turn on itself and to be pushed against the wall. A swirl in the siphon enhances the mechanical cleaning action. Indeed, this swirl of water provides cleaning by scraping the walls of the siphon. Moreover, the stick, made to rotate, also scrapes the wall of the siphon.

On the other hand, the stick of the invention retains its chemical cleaning action, by virtue of the active agents contained in this stick. These active agents are indeed released during the dissolution of the stick in the water. These active agents act on the grease and residues contained in the pipes.

The stick 40 of FIG. 4 comprises vanes 5. These vanes 5 cause the stick 40 to rotate in the siphon under the action of the water pressure.

1. Household stick (1; 10; 30; 40) for the cleaning of household drainage wastewater pipes designed to be blocked at the inlet of the pipe, in order to dissolve under the action of the water and release a cleaning agent and, in addition to the action of the agent, to perform a mechanical cleaning, the stick being characterized in that it is designed to be rotated under the action of the water.

2. The cleaning stick (1; 10) according to claim 1, comprising a helicoidal relief (2; 3) on its wall.

3. The cleaning stick (40) according to claim 1, comprising rotary vanes (5).

4. The cleaning stick (30) according to claim 1, comprising scraping means (4).
